(19) United States
(12) Patent Application Publication
(10) Pub. No.: US 2026/0048806 A1
(43) Pub. Date: Feb. 19, 2026

(54) SWITCHABLE MECHANICAL SOUND EMITTING DEVICE WITH EXTERANALLY MOUNTED STRIKER

(71) Applicant: Philip Powers, Lafayette, CO (US)

(72) Inventor: Philip Powers, Lafayette, CO (US)

(21) Appl. No.: 19/319,717

(22) Filed: Sep. 4, 2025

Related U.S. Application Data
(63) Continuation of application No. 17/502,641, filed on Oct. 15, 2021.

(51) Int. Cl. B62J 45/10; B62J 45/41; G06F 3/16; G08B 21/02

(52) U.S. Cl. CPC B62J 45/10; B62J 45/41; G06F 3/16; G08B 21/02

(57) ABSTRACT

A motion-activated mechanical sound-emitting device includes at least one ringer and at least one striker supported outside the ringer. A user actuator selects between an on state, in which motion permits the striker to contact the ringer to emit sound, and an off state, in which contact is prevented by moving one or both components away from one another or by interposing a blocker. Striker-support components remain outside the ringer, with no portion disposed within or passing through the ringer. The device is operable in any orientation and, in some embodiments, is spring-free and provides intermediate positions for partial sound reduction. The device can be mounted to a wide variety of moving hosts, such as a bicycle, backpack strap, pet collar, horn of a saddle, wheelchair, motorized scooter, or robot, and may employ multiple striker-ringer pairings.

This application is a continuation of U.S. patent application Ser. No. 17/502,641, filed Oct. 15, 2021, which claims priority to U.S. Provisional Ser. No. 63/093,584 , filed Oct. 19, 2020. The entire disclosures of both prior applications are incorporated herein by reference.

### STATEMENT UNDER 37 C.F.R. §§ 1.121(b)(3) AND 1.125

The following substitute specification (excluding the claims) contains no new matter.

FIGS. 1-14 and 47-48 are canceled for prosecution convenience only, without disclaimer of subject matter.

### TECHNICAL FIELD

This disclosure relates generally to outdoor recreation. In particular, the following description relates to trail safety during outdoor recreation through audible signaling.

### BACKGROUND

Cyclists are capable of moving much more quickly than pedestrians and, as they are often rather quiet, have a tendency to startle pedestrians when they suddenly come upon them, or, in a worst case scenario, even collide with them. This is fairly common on tight (single track) trails in the woods. The same issue can occur when a cyclist happens upon a bear, moose, or other wildlife when in the woods. It can also occur between a slow moving and fast moving cyclist, or between cyclists headed in opposing directions.

Similarly, hikers or backpackers can easily startle wildlife if the wildlife sees them nearby before they are heard. This has resulted in wildlife charging or attacking humans in the backcountry.

When hiking with their pets, many pet owners attach mechanical bells or other noise making devices to their pets to hear where they are located, to alert other trail users to the pet, and to alert wildlife. Some parents will do the same with their children when hiking. Thus, improvements in alerting systems for outdoor recreation continue to be of interest.

### SUMMARY

Embodiments of a switchable mechanical motion activated sound device include a sound emitting device that can be used during an activity where the user is in motion and a sound emitting device would have utility, and where the ability to enable, dampen or disable the sound has utility. The switchable mechanical motion activated sound device is capable of emitting sound loud enough that individuals in the vicinity are aware of the general location it is being emitted from. Sound formation can be dependent on movement of the object to which the device is coupled.

Some applicable activities include, but are not limited to, biking, hiking, walking, running, skiing, roller-blading, snowshoeing, etc. There exist a plurality of options for coupling the motion activated sound device to a person, animal, object, or some combination thereof during an activity. Some locations can include on the user, on an accessory the user is wearing, or on the mode of transportation the user is operating.

A motion activated sound device can be fastened to a wheeled transportation device similar or related to a unicycle, bicycle, or tricycle on areas such as the handlebars, seat post, or frame components. The motion of the transportation device can be utilized by the motion activated sound device to both effect and affect the emission of sound. Additionally, the switchable mechanical motion activated sound device can have different states of functionality where more, or less, sound is emitted; these states are referred to herein as “on state” and “off state” respectively. Sound emitted is most clamorous in the on state, and least clamorous in the off state.

A dampened state wherein sound emitted from the device is lower in volume, cadence and/or other characteristics when compared to the on state, but not eliminated as in the off state, can be achieved by setting the device to varying degrees between the on and off states. The closer the device is set to the on state, the more clamorous the sound. Conversely, the closer the device is set to the off state, the less clamorous the sound.

A motion activated sound device can be coupled directly to the user in a wide variety of use cases including those listed previously. Common areas a user can fasten the device to their body include arms, legs, and neck. Through the use of an adjustable fastening device such as an elastic band or cinching band, the motion activated sound device can be mounted to any point on the user's body that the user sees fit.

A motion activated sound device can be fastened to an article of clothing or an accessory piece of equipment on the user's body. During activities such as hiking, a user is likely to be wearing or carrying pieces of equipment such as jackets, backpacks, hiking poles or other gear. Fastening the device to an article of clothing or accessory equipment can allow the user versatility for where they can mount the device.

These and other embodiments are discussed below with reference to the drawings. However, those skilled in the art will readily appreciate that the detailed description given herein with respect to these drawings is for explanatory purposes only and should not be construed as limiting.

### BRIEF DESCRIPTION OF THE DRAWINGS

For a more complete understanding of this disclosure and its advantages, reference is now made to the following description, taken in conjunction with the accompanying drawings.

FIG. 1 illustrates a perspective view of an embodiment of the switchable mechanical motion activated sound device wherein the ringer is coupled internally to an external striker and motion of the striker cannot create sound with the actuation device in the off state.

FIG. 2 illustrates a side view of the sound device shown in FIG. 15, showing the actuation device in the off state, having moved the striker away from the ringer such that the striker and ringer cannot contact one another.

FIG. 3 illustrates a side view of the sound device shown in FIG. 15, showing the actuation device in the on state, having moved the striker into a position where the striker and ringer can contact one another.

FIG. 4 illustrates the cross section of a side view of the sound device shown in FIG. 15, wherein the actuation device is shown in the on state and the striker and ringer can contact one another.

FIG. 5 illustrates the cross section of a side view of the sound device shown in FIG. 15, wherein the actuator is in the off state such that the external striker has been moved away from the ringer and cannot contact the ringer.

FIG. 6 illustrates a perspective view of an embodiment of the switchable mechanical motion activated sound device wherein the striker can be coupled internally to an external ringer and motion of the striker can create sound when the actuation device is in the on state.

FIG. 7 illustrates a side view of the sound device shown in FIG. 20, showing the actuation device in the on state moving the striker into a position such that the striker and ringer can contact one another.

FIG. 8 illustrates a perspective view of the sound device shown in FIG. 20, showing the actuation device in the off state, having moved the striker away from the ringer such that the striker and ringer cannot contact one another.

FIG. 9 illustrates a side view of the sound device shown in FIG. 20, showing the actuation device in the off state moving the striker away from the ringer such that they cannot contact each other.

FIG. 10 illustrates the cross section of a side view of the sound device shown in FIG. 20, wherein the internal striker can be moved closer to the ringer so that it can contact the external ringer by manipulating the actuation device into the on state.

FIG. 11 illustrates the cross section of a side view of the sound device shown in FIG. 20, wherein the internal striker can be moved away from the ringer such that it is unable to contact the external ringer by manipulating the actuation device into the off state.

FIG. 12 illustrates a perspective view of an embodiment of the switchable mechanical motion activated sound device wherein the ringer can be coupled internally to an external striker and motion of the ringer can create sound when the actuation device is in the on state.

FIG. 13 illustrates a side view of the sound device shown in FIG. 26, showing the actuation device in the on state, having moved the internal ringer into a position such that the external striker can contact the ringer.

FIG. 14 illustrates a perspective view of the sound device shown in FIG. 27, showing the actuation device in the off state, having moved the internal ringer into a position wherein the external striker cannot contact the ringer.

FIG. 15 illustrates a side view of the sound device shown in FIG. 26, showing the actuation device in the off state having moved the internal ringer into a position wherein the external striker cannot contact the ringer.

FIG. 16 illustrates a perspective view of an embodiment of the switchable mechanical motion activated sound device wherein the striker can be coupled internally to an external ringer and movement of the ringer can create sound when the actuation device is in the on state.

FIG. 17 illustrates a side view of the sound device shown in FIG. 30, showing the actuation device in the on state such that the internal striker can contact the ringer.

FIG. 18 illustrates a perspective view of the sound device shown in FIG. 30, showing the actuation device in the off state, having moved the external ringer into a position wherein the internal striker cannot contact the ringer.

FIG. 19 illustrates a side view of the sound device shown in FIG. 30, showing the actuation device in the off state such that the internal striker cannot contact the ringer.

FIG. 20 illustrates a cross section of a side view of the sound device shown in FIG. 30, showing the actuation device in the on state, having moved the external ringer into a position wherein the internal striker can contact the ringer.

FIG. 21 illustrates a cross section of a side view of the sound device shown in FIG. 30, showing the actuation device in the off state, having moved the external ringer into a position wherein the internal striker cannot contact the ringer.

FIG. 22 illustrates a perspective view of an embodiment of the switchable mechanical motion activated sound device wherein an interference device such as a wedge can be moved into a position internal to the ringer and external to the striker to reduce or eliminate sound.

FIG. 23 illustrates a side view of the sound device shown in FIG. 36, showing the actuation device in the off state, having moved the internal wedge into a position wherein the striker cannot contact the external ringer.

FIG. 24 illustrates a perspective view of the sound device shown in FIG. 36, showing the actuation device in the on state, having moved an internal wedge into a position wherein the striker can contact the external ringer.

FIG. 25 illustrates a side view of the sound device shown in FIG. 36, showing the actuation device in the on state, with the internal wedge withdrawn into a position wherein the striker can contact the external ringer.

FIG. 26 illustrates a cut away view of the sound device shown in FIG. 36, showing the actuation device in the off state, having moved the internal wedge into a position wherein the striker cannot contact the external ringer.

FIG. 27 illustrates a cut away view of the sound device shown in FIG. 36, showing the actuation device in the on state with the internal wedge withdrawn into a position wherein the striker can contact the external ringer.

FIG. 28 illustrates a perspective view of an embodiment of the switchable mechanical motion activated sound device wherein a clip device can be coupled to a base member of the switchable mechanical motion activated sound device.

FIG. 29 illustrates a perspective view of the switchable mechanical motion activated sound device depicted in FIG. 42, wherein the attachment device can be coupled to a side of the sound device.

FIG. 30 illustrates a perspective view of the switchable mechanical motion activated sound device depicted in FIG. 26, wherein the attachment device at the bottom of the device can be coupled to a strap.

FIGS. 31-32 illustrate perspectives view of the switchable mechanical motion activated sound device, wherein the sound device can be coupled to other objects.

Those skilled in the art will appreciate and understand that, according to common practice, various features of the drawings discussed are not necessarily drawn to scale, and that dimensions of various features and elements of the drawings can be expanded or reduced to more clearly illustrate the embodiments described herein.

### DETAILED DESCRIPTION

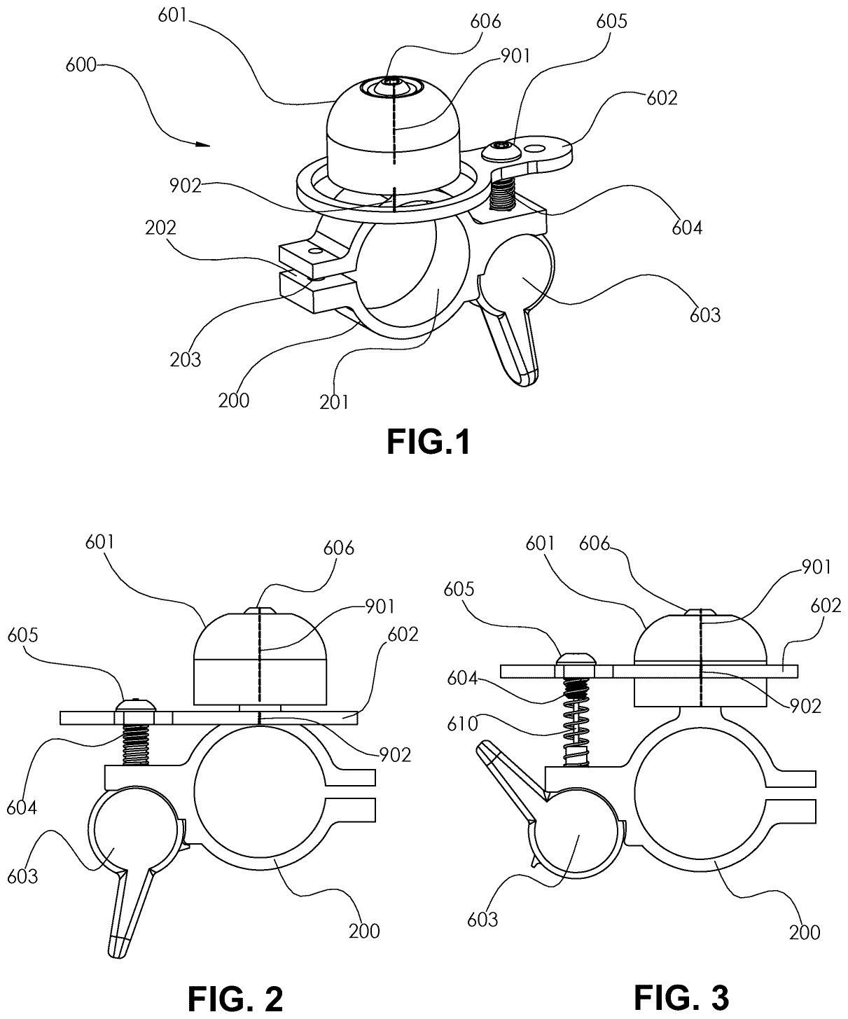

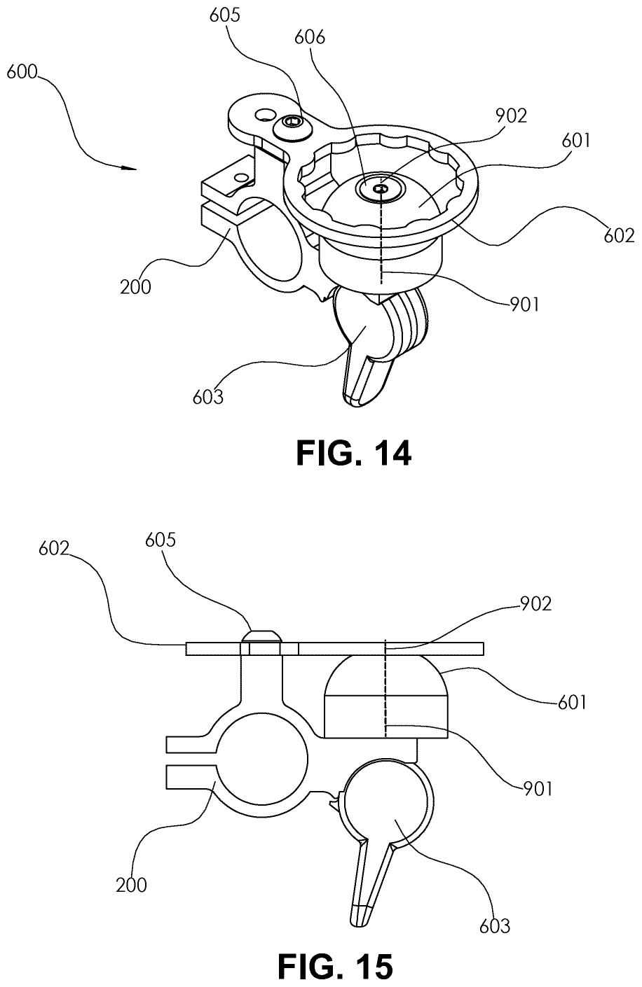

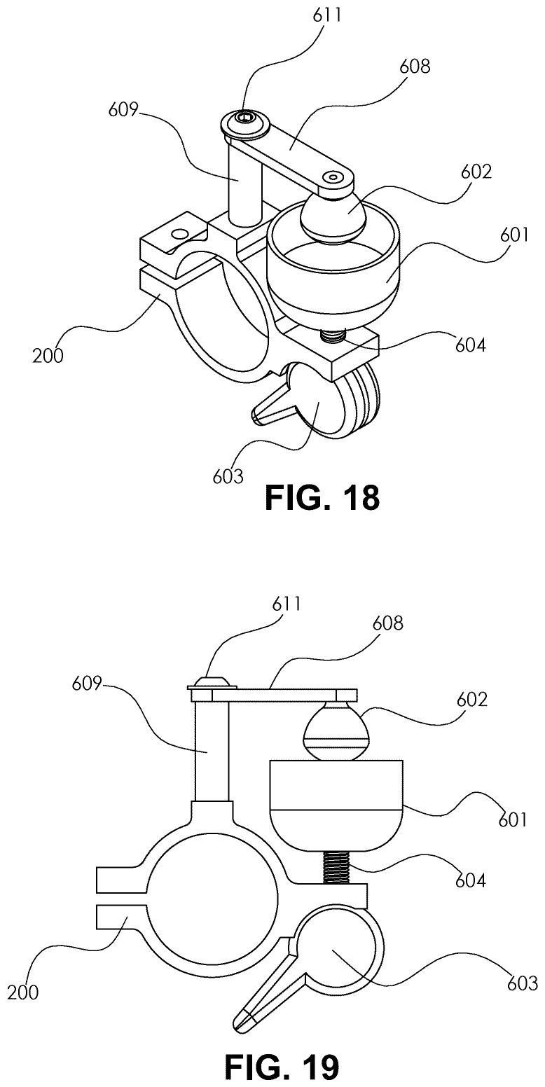

FIGS. 1-18, discussed below, and the various embodiments used to describe the principles of this disclosure are by way of illustration only and should not be construed in any way to limit the scope of the disclosure.

Consistent with the above disclosure, the examples of systems and method enumerated in the following clauses are specifically contemplated and are intended as a non-limiting set of examples. Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Many cities and municipalities provide dedicated pedestrian throughways that are used by people for walking, jogging, bicycling, rollerblading/skating, or any other means of conveyance, for both recreational and practical transportation purposes. It is also common to see such pedestrian traffic on city streets, sidewalks, side roads or even open country highways. Furthermore, many other private and public access wilderness or park areas provide trails that are used for similar activities such as mountain biking, hiking or cross-country skiing. As both a courtesy to other trail users, and as a safety measure, it is appropriate to be equipped with a device, such as a bell, that can be rung or otherwise activated when approaching others from behind, or entering blind spots such as corners, tunnels or similar obstacles, so as not to startle or surprise other people or animals. Some cities even require, by ordinance or decree, that cyclists or other fast-moving trail users must be equipped with such a device.

Relative to safety measures, the same logic applies to wildlife, or animals and pets in general, whether in remote wilderness or urban areas, or any setting in between. Providing an audible alert may prevent a trail user from startling an animal and minimize an unpredictable reaction or otherwise dangerous encounter. The scenario of a hiker startling a bear in the woods serves as a good example. If environmental factors are right, a hiker could walk up on a bear without either one seeing the other. If the bear becomes agitated the encounter may result in a negative outcome.

It is not practical to presume a trail user can reliably anticipate when an audible alert would be prudent in any given situation, nor is it always possible or safe for a cyclist, or the like, to manually ring a bell especially while braking or performing other tasks required to keep control of their bicycle. Furthermore, the act of ringing a bell can often be misinterpreted by the hearer as the person ringing the bell requesting permission to pass or declaring that they have right of way on a trail. The current disclosure presents a motion activated sound device that can automatically emit noise when in motion and can also be switched between on states and off states.

The motion activated sound device can be worn by the user, coupled to equipment, gear or clothing using a plurality of methods or stored therein. Examples of use context are included herein as a plurality of embodiments that allow it to be coupled via a bar mount, such as to a bicycle handlebar or seat post, a strap that can be worn on the body or a clip that can be attached to clothing. The device can be configured to operate in any mounted orientation; upright, sideways, upside down or any position in between. The user can be an adult, child, athlete, laborer or the like, or a domesticated pet or other animal.

In the most basic mode of operation, the motion activated sound device emits a continuous audible signal only while the user is in motion. The audible signal emitted by the motion activated sound device may be used to alert other people or animals to the user's presence. This may be important when a user is moving in an area in which they may encounter or overtake another person or animal without a visual or audible indication otherwise.

A more advanced mode of operation can involve automatic adjustments to the audible signal based on device settings and on the presence, or absence, of motion. Elements or attributes of the audible signal, such as volume, tone, frequency, dynamics or melody may be programmed to change when the user stops moving. Increasing the sound level or changing the sound to a different alarm sound or melody while the user is at rest may be beneficial in use case situations where the idle user is blind to oncoming traffic by hills, corners or other obstacles. In such cases a louder or more distinguishable audible signal may be appropriate. Conversely, decreasing the volume while the user is at rest may be more appropriate in situations where other forms of communication are desired or a there exists a higher priority over the audible signal. Once motion resumes, the audible signal can continue as modified or return to the original, a random, or a predetermined setting.

The motion activated sound device can also be set to emit an audible signal only when not in motion so as to alert others within earshot of the device that the user is no longer moving or has otherwise stalled. Use cases may be similar to those described above where the user is blinded to oncoming traffic or for any situation where an audible signal from an idle user is of interest to others but is not needed when the user is in motion.

Use of the motion activated sound device is not limited to recreational activities, but may be used in any situation or high risk environment where the location of an individual relative to equipment or other users is paramount or the unexpected presence of a person may startle someone or present a safety hazard. A warehouse or factory worker may use the motion activated sound device while moving about a production area to alert forklift drivers to their presence. Workers performing tasks that limit their ability to see oncoming foot traffic or other hazards, such as a person engaged in heavy lifting or a task that must be performed peripatetically may use the motion activated sound device. Additionally, the motion activated sound device may have applications related to training of people or animals, monitoring of assets or people, safety protocols or other industrial uses.

The bar mount 200 can contain a tubing mount interface 201 that allows it to be coupled with tubing of a plurality of cross sections or profiles. Thus, the motion activated sound device 100 can then be coupled to an array of items, generally tubular in shape, in a rigid manner yet readily decoupled when desired.

The clip mount 231 can be coupled to the base assembly 110 by a plurality of fastening means. The clip mount 231 can be decoupled from the base mount 150 as desired to allow coupling of the other mounting options to the base assembly 110 as detailed herein. Alternatively, the clip mount 231 can be integral to the base assembly 110 allowing direct connection to the strap 220.

Embodiments of the switchable mechanical motion activated sound device may consist of one or more ringers, one or more strikers, one or more attachment devices and a means of coupling the striker(s) and ringer(s) to said attachment device or devices. In the on state, the striker, ringer or both can freely oscillate with varying magnitude, position or frequency, relative to each other or about a central point. This movement, produced while the switchable mechanical motion activated sound device is in motion, allows contact between the striker and ringer, thereby emitting sound. A means of manipulating either the striker, the ringer, a wedge, brace, cam or damping device, or any combination thereof, such that the sound produced is greatly reduced or eliminated is used to set the switchable mechanical motion activated sound device to a dampened or off state. In this state, the switchable mechanical motion activated sound device may emit reduced or no sound even while in motion.

The ringer can be in the shape of any type of bell, a bar (similar to a xylophone), a circular or semi-circular shape, or any other shape and material which can be constructed to have a resonant frequency within the range of human hearing. The typical range of human hearing is between 20 Hz and 20,000 Hz, allowing the possibility for the ringer to exist in size from very large to very small. Additionally, certain characteristics of the sound, or the level of sound, can be altered by changing the shape, weight or other physical attributes of the striker and/or ringer, or by modifying the attachment device. As a few examples, the increased mass of a heavier striker may produce a louder sound; a longer spring coupled to the striker may produce a louder sound as the amplitude of motion increases; a stiffer spring may decrease the frequency of the oscillations. Combined with the ability to reduce the overall sound produced by adjusting the device below the on state, but not fully to the off state, variable damping of the device can be achieved.

The striker can be in the shape of an ordinary bell clapper, a bar, a hoop, a semi-circle, an organic shape, or virtually any other shape imaginable such as a small scale bicycle or Statue of Liberty. It can cause the ringer to emit sound when it is struck from the outside, from the inside, or from an adjacent position (above, below, from the right, from the left, etc.). Unlike the ringer, the striker does not need to have a resonant frequency, but simply the ability to impact the ringer. In general, a striker made from a hard material will have a higher likelihood of creating a clear, loud sound from the ringer.

In order for the switchable mechanical motion activated sound device to emit sound when in motion, the striker and the ringer must be able to contact one another. The switchable mechanical motion activated sound device can be configured with a plurality of ringers, a plurality of strikers, or both. In general, it is best to allow a greater degree of freedom (of motion) for the striker(s) and a lesser degree of freedom (of motion) for the ringer(s) or vice versa in order to emit a larger amplitude sound.

A lesser degree of freedom for the ringer can be created by coupling the ringer to the attachment device in a way which prevents large amplitude movements, but in a way which does not constrain the ringer such that the amplitude of the audible resonant frequency is too small to be heard. Similarly, a lesser degree of freedom in the striker can be created by more rigidly coupling the striker relative to the attachment device.

A greater degree of freedom for the ringer or the striker can be created by coupling either to the attachment device or to the activation component (lever, switch, button, etc.) using a flexible material such as, but not limited to, a cable, a spring, string or rope, a piece of fabric, rubber, or any other flexible material. A spring used to couple them can be in the form of a compression spring, a torsion spring, a leaf spring, an extension spring, or any other shape of spring material such as steel or plastic.

The switchable mechanical motion activated sound device can also be configured in such a way that both the ringer and the striker have a large degree of freedom to create a different audible effect.

The motion activation state of the switchable mechanical motion activated sound device can be changed by engaging a switching component such as, but not limited to, a lever, button, or switch. There are a plurality of ways to accomplish this. When the user engages said component, the striker can be moved into a position where it can contact the ringer or vice versa: the ringer can be moved into a position where it can contact the striker. This process can be reversed and the user can engage the switching component to move either the ringer or the striker away from the other such that they are not able to contact one another.

Another option is that the switching component can move an interference component, such as, but not limited to a wedge, brace, ring, or damper, between the ringer and striker such that the ringer and striker cannot contact one another. The switching component can then be engaged such that the interference component is removed from between the ringer and striker to allow the ringer and striker to contact one another.

The term “on” is used to mean the state in which sound can be produced and the term “off” is used to mean the state in which either a very small amount of sound occurs or no sound at all.

An exemplary use case of the switchable mechanical motion activated sound device can be configured to be mounted to the handlebar of a bicycle. As the handlebar of the bicycle moves, the device will move with it, thereby producing a sound when the switching component is in the on condition. When the switching component is in the off condition, the device will cease to sound or greatly decrease in sound as the handlebar continues to move. The switchable mechanical motion activated sound device can be mounted in any orientation though typically, depending on the configuration of the device, one or two orientations will allow the ringer and striker to impact more frequently or with more force to produce a more frequent or louder sound.

The switchable mechanical motion activated sound device can be turned off when the lever, button, or switch moves the ringer or the striker to a position where it is either a) unable to be contacted by the other, be it the ringer or striker, b) pressed against the other, c) an intermediate component or series of components is placed in such a position as to prevent the ringer and striker from contacting one another, or d) the ringer is dampened by a separate body so that it does not ring when struck.

There are other means of configuring a ringing device which can be shutoff, many of which don't require a third member such as a button, switch or lever. One such option is to physically reposition the moveable member, be it the ringer or the striker, to a location where it cannot contact the other. This can be done by sliding, pivoting, bending, twisting, compressing, or extending one of the components to a location where it cannot be reached by the other. Another such option is to physically secure the moveable member to prevent the ringer and striker from contacting one another. For example, if the ringing device is comprised of a striker and a ringer with the ringer being the moveable member and being external to the striker, the flexible member holding the ringer can be compressed and the ringer can be twisted to engage teeth on the attachment member, thereby preventing the ringer from contacting the striker. “Moveable member” is defined herein as the component with the greater degree of freedom of the two.

A possible configuration of the switchable mechanical motion activated sound device includes a secondary striker which can be used manually, as needed, to strike the ringer. This can be done within almost any configuration of the ringing device and with almost any form of striker. This can be configured to function when the switching component is in the off or the on position. It enables the user to alert others in the vicinity when the switching component is in the off position or when the switching component is in the on position, but the motion of the device is of insufficient amplitude to otherwise generate sound.

The switchable mechanical motion activated sound device can be configured to be attached to nearly anything including but not limited to, a backpack, a dog collar, the strap of a bag, the body or extremity of a user, the top of a medical delivery robot in a hospital, the horn of a horse's saddle, a wheelchair, bicycle, motorized scooter, or ski pole.

FIGS. 1-5 illustrate a first embodiment of the switchable mechanical motion activated sound device 600 wherein an internal ringer 601 with an axis 901 can be coupled to an external striker 602 with an axis 902. Ringer 601 and striker 602 can be coaxial. Motion of the striker 602 can create sound when the actuation device 603 is in the on state but cannot create sound or the sound is greatly reduced when the actuation device 603 is in the off state. As shown, the switchable mechanical motion activated sound device 600 can include a ringer 601, coupled to the switchable mechanical motion activated sound device 600 by a ringer attachment component 606, striker 602, spring 604, bar mount 200 and an actuation device 603. Motion of the switchable mechanical motion activated sound device 600 moves the striker 602 to strike the ringer 601 to produce a sound when the actuation device 603 is in the on state.

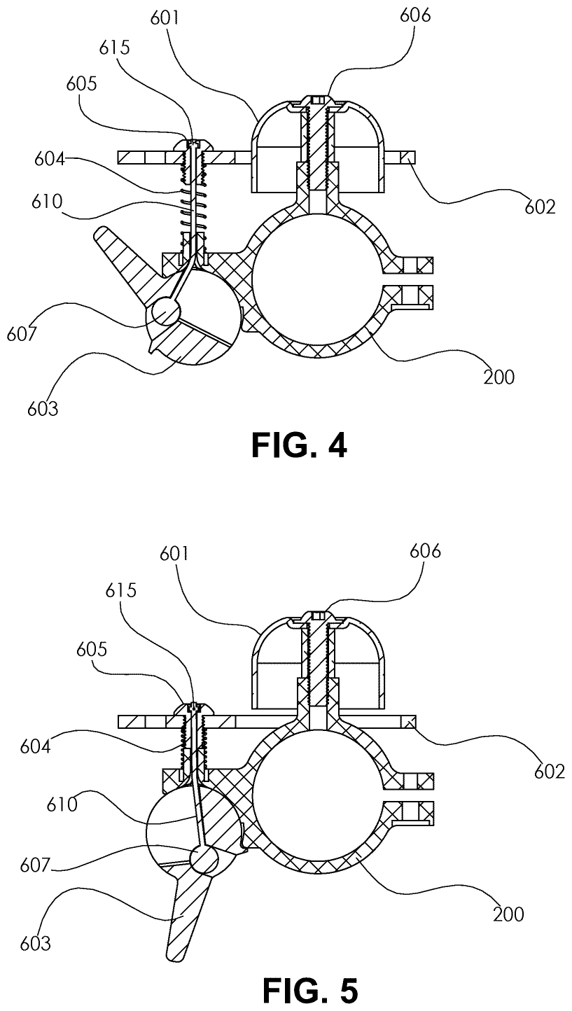

FIGS. 1, 2, and 5 illustrate the actuation device 603 in the off state preventing the striker 602 from contacting the ringer 601, in turn minimizing or eliminating the ringing sound. In the off state, the striker 602 can be axially spaced apart from the ringer 601, such that there is no axial overlap between them. FIGS. 3 and 4 illustrate the actuation device 603 in the off state, a position in which the external striker 602 can contact the ringer 601. Rotational movement of the actuation device 603 (clockwise, in FIG. 5) from the off state to the on state (FIG. 4) moves the external striker 602 into closer proximity to the internal ringer 601. In contrast, rotational movement of the actuation device 603 (counterclockwise, in FIG. 4) from the on state initiates increasingly restrictive motion of the external striker 602, gradually dampening amplitude of motion and, thereby, reducing the sound emitted from the device 600. Full retraction of the striker 602 into the off state (FIG. 19) moves the striker 602 away from the ringer 601 such that little or no sound is emitted from the device 600.

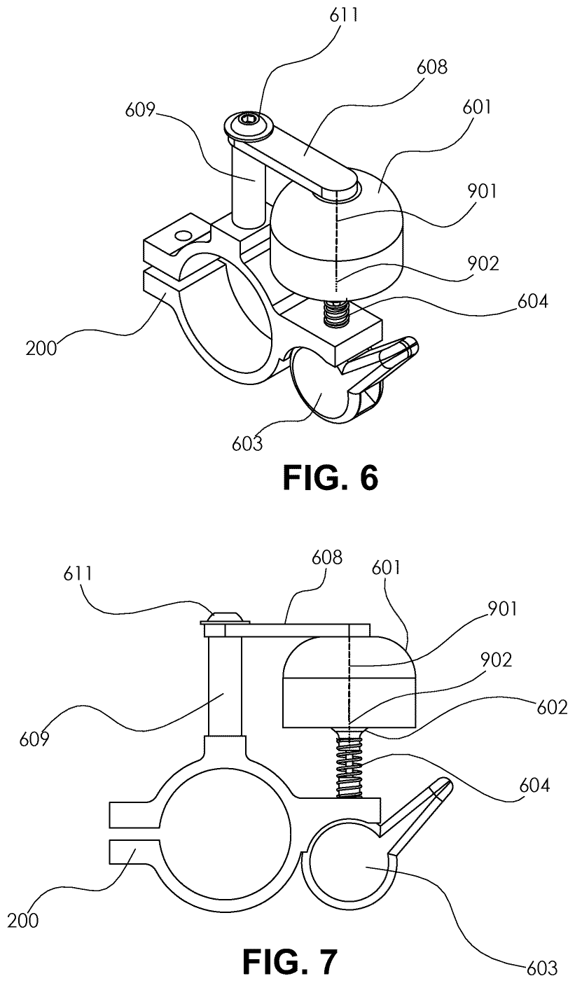

FIGS. 6-11 illustrate views of another embodiment of the switchable mechanical motion activated sound device 600 wherein an internal striker 602 with an axis 902 can be coupled with a ringer 601 having an axis 901. As with other embodiments, the ringer 601 and striker 602 can be coaxial. Embodiments of the switchable mechanical motion activated sound device 600 can include a ringer 601 suspended above a movable internal striker 602 by a ringer arm 608 coupled to a ringer post 609 with an arm fastener 611. An actuation device 603 can turn the switchable mechanical motion activated sound device 600 from an on state to an off state, and back again, to control sound emitted by the ringer 601. In the shown embodiment, the switchable mechanical motion activated sound device 600 is coupled to a bar mount 200.

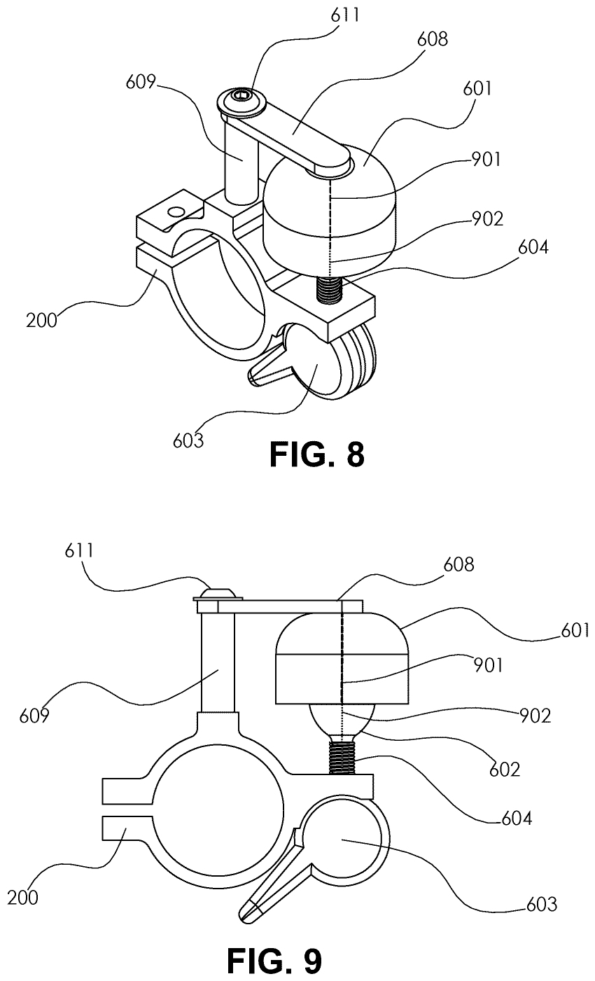

Referring to FIGS. 8-11, wherein like numerals indicate corresponding parts throughout the views, embodiments of the switchable mechanical motion activated sound device 600 are shown. An internal striker 602 can contact the inside surface of a ringer 601 while the actuation device 603 is in the on state, thereby emitting sound as the switchable mechanical motion activated sound device 600 is in motion. The internal striker 602 can be coupled to an actuation device 603 through a linkage connection 607, linkage component 610 and a spring 604. FIGS. 8, 9 and 11 illustrate the actuation device 603 preventing the internal striker 602 from contacting the ringer 601, in turn minimizing or eliminating the ringing sound. The striker 602 and ringer 601 can axially move apart, while still axially overlapping (FIG. 11), but being unable to contact each other when at rest.

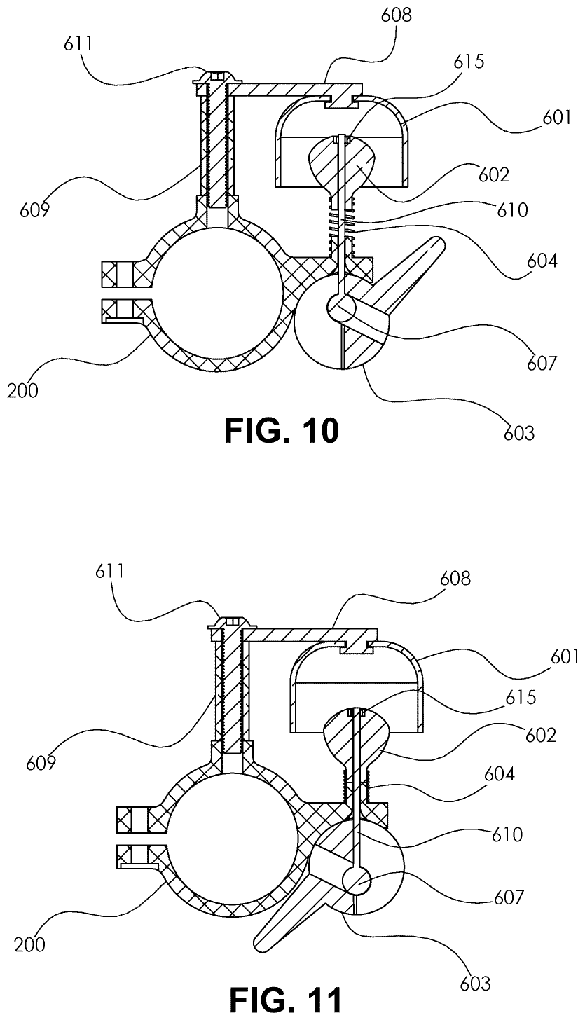

FIGS. 6, 7 and 10 illustrate the actuation device 603 in a position in which the external striker 602 can contact the ringer 601. Rotational movement of the actuation device 603 (counterclockwise, in FIG. 11) from the off state to the on state (FIG. 10) moves the internal striker 602 into closer proximity to the external ringer 601. In contrast, rotational movement of the actuation device 603 (clockwise, in FIG. 10) initiates increasingly restrictive motion of the internal striker 602, gradually dampening amplitude of motion and, thereby, reducing the sound emitted from the device 600. Full retraction of the striker 602 to the off state (FIG. 11) moves the striker 602 away from the ringer 601 such that little or no sound is emitted from the device 600.

The striker 602 and ringer 601 can axially move apart, while still axially overlapping (FIG. 15), but being unable to contact each other.

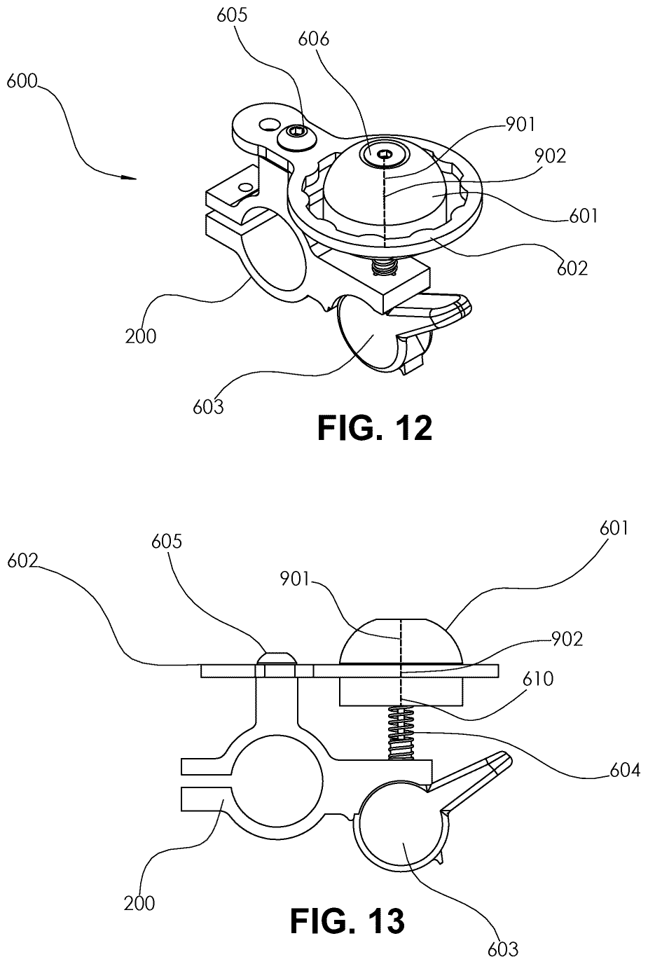

FIGS. 12-15 illustrate a third embodiment of the switchable mechanical motion activated sound device 600 wherein a ringer 601 with an axis 901 can be moved toward a stationary external striker 602 having an axis 902 to allow contact between the ringer 601 and the striker 602. The embodiment shown can consist of a bar mount 200, a ringer 601 coupled to an actuation device 603 with a ringer attachment component 606, a striker 602 coupled to the switchable mechanical motion activated sound device 600 with a striker attachment component 605, a spring 604, and a linkage component 610 linking the ringer 601 and actuation device 603. In the embodiment shown, the user can manipulate the actuation device 603 until the spring 604 is no longer compressed, or in the off state, and the ringer 601 is able to move into the on state position where it is free to contact the striker 602. Rotational movement of the actuation device 603 (counterclockwise, in FIG. 15) from the off state to the on state (FIG. 13) moves the internal ringer 601 into closer proximity to the external striker 602. In contrast, rotational movement of the actuation device 603 (clockwise, in FIG. 13) from the on state initiates increasingly restrictive motion of the ringer 601, gradually dampening amplitude of motion and, thereby, reducing the sound emitted from the device 600. Full retraction of the ringer 601 to the off state (FIG. 15) moves the ringer 601 away from the striker 602 such that little or no sound is emitted from the device 600.

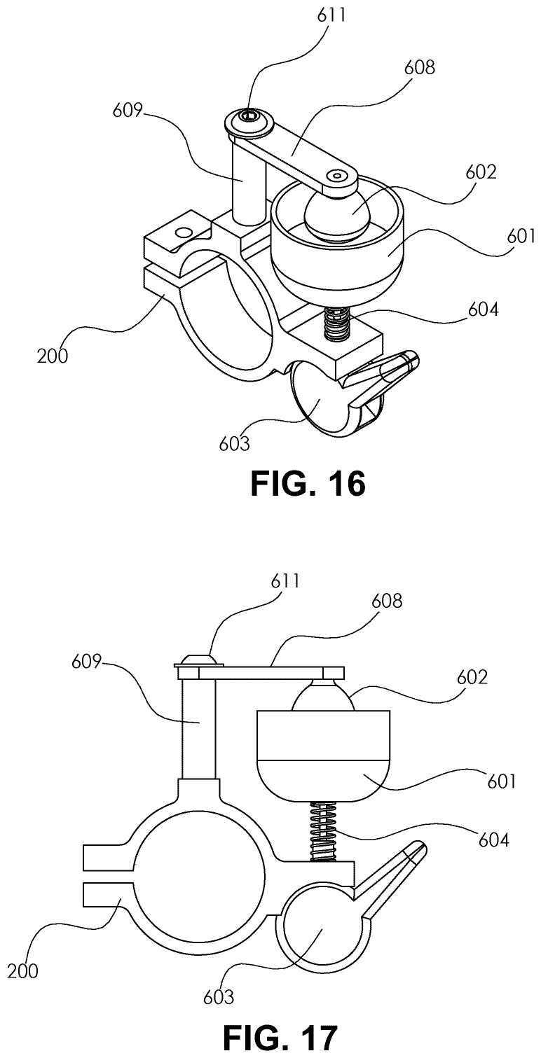

FIGS. 16-21 illustrate a fourth embodiment of the switchable mechanical motion activated sound device 600, in accordance with some embodiments, wherein the ringer 601 can move away from a stationary internal striker 602. The embodiment is shown in an orientation with the internal striker 602 above the ringer 601, but it can be coupled to a plurality of objects in any orientation, in accordance with some embodiments. The switchable mechanical motion activated sound device 600 can be configured in a preferred orientation with the internal striker 602 below the ringer 601 and can be done without the use of a spring 604. A plurality of shapes and sizes can be used in place of the ringer 601, the internal striker 602, or the actuation device 603 shown. In the embodiment shown, the internal striker 602 is coupled to the bar mount 200 using a first 609, second 611, and third 608 member, though this can be accomplished with any number of members or the internal striker 602 can be an integral part of the attachment device.

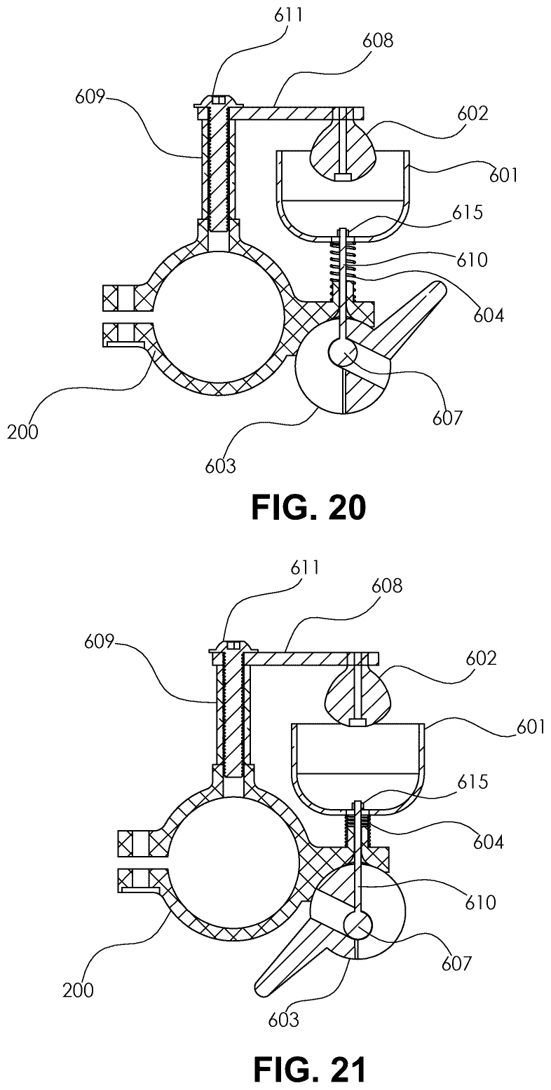

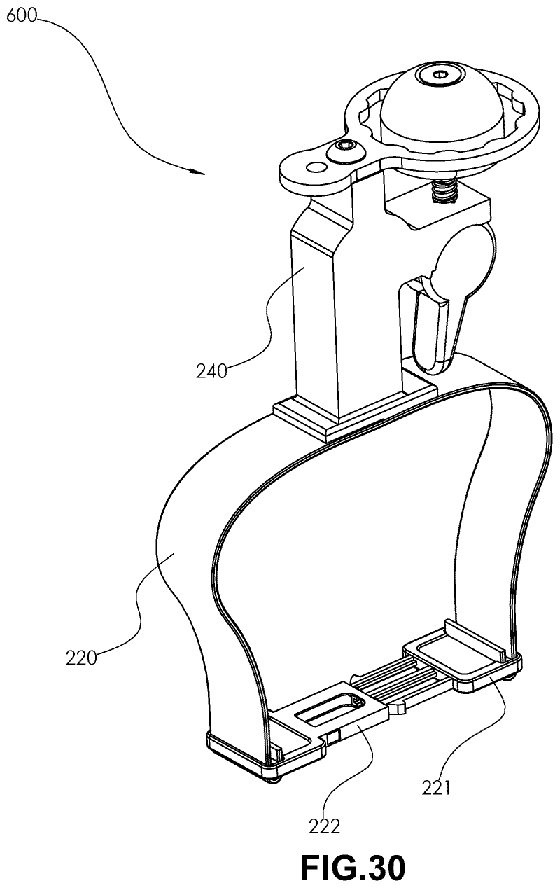

FIG. 20 illustrates a cross section of a side view of the sound device shown in FIG. 30, showing the actuation device 603 having moved the external ringer 601 into the on state position wherein the internal striker 602 can contact the ringer 601.

FIG. 21 illustrates a cross section of a side view of the sound device shown in FIG. 30, showing the actuation device 603 having moved the external ringer 601 into the off state position wherein the internal striker 602 cannot contact the ringer 601. Rotational movement of the actuation device 603 (counterclockwise, in FIG. 21) from the off state to the on state (FIG. 20) moves the external ringer 601 into closer proximity to the internal striker 602. In contrast, rotational movement of the actuation device 603 (clockwise, in FIG. 20) from the on state initiates increasingly restrictive motion of the internal ringer 601, gradually dampening amplitude of motion and, thereby, reducing the sound emitted from the device 600. Full retraction of the ringer 601 to the off state (FIG. 21) moves the ringer 601 away from the striker 601 such that little or no sound is emitted from the device 600.

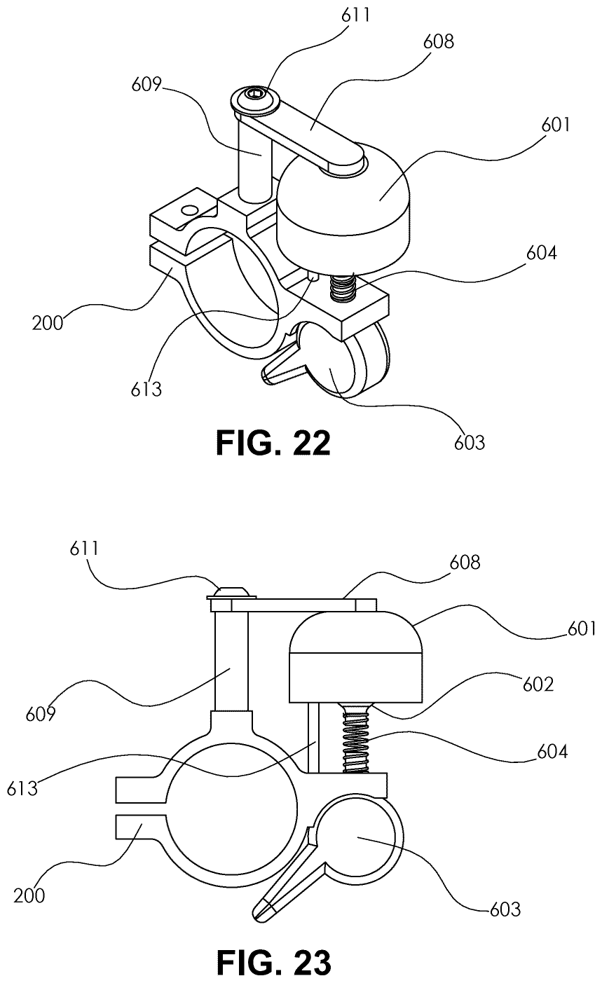

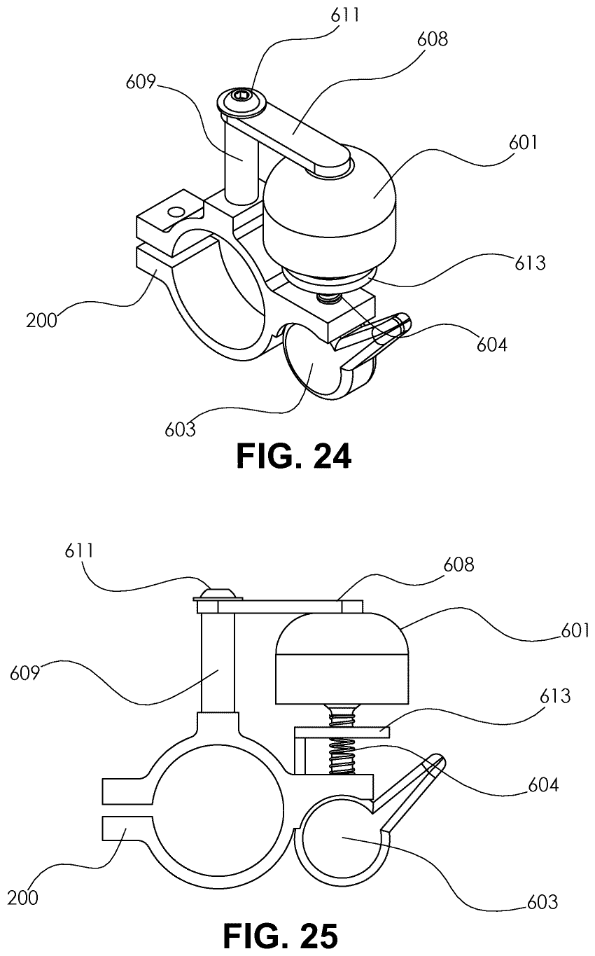

FIGS. 22-27 illustrate a perspective view of an embodiment of the switchable mechanical motion activated sound device 600 wherein an interference device 613 such as a wedge or brace can be moved into a position internal to the ringer 601 and external to the striker 602 to reduce or eliminate sound, in accordance with some embodiments. The interference device 613 can be a plurality of shapes or sizes and can be used in a plurality of embodiments. It can be configured to function in a position where it is external to a ringer 601 and internal to a striker 602 or where it is in between an adjacent ringer 601 and striker 602. It can be configured to reduce the sound to varying degrees and can be configured to eliminate sound altogether.

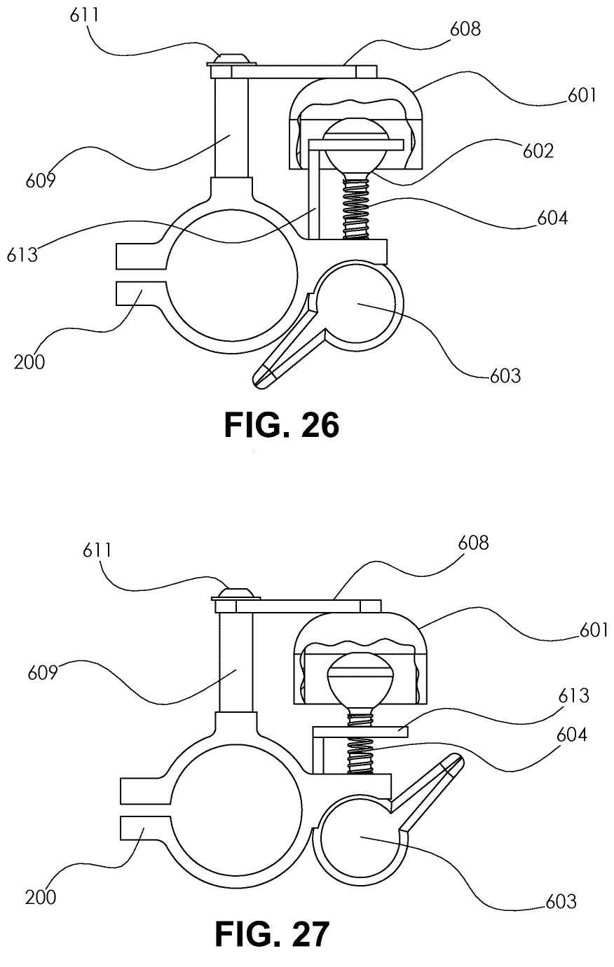

FIGS. 26-27 illustrate the actuation device 603 in both the off state, where the interference device 613 is engaged, and the on state, where the interference device 613 is not engaged thereby either minimizing or maximizing sound emitted from the ringer 601 when contact with the striker 602 is made. Rotational movement of the actuation device 603 (counterclockwise, in FIG. 26) from the off state to the on state (FIG. 27) moves the interference device 613 away from interfering with contact between the external ringer 601 and the internal striker 602. In contrast, rotational movement of the actuation device 603 (clockwise, in FIG. 27) from the on state initiates increasingly restrictive motion of the internal striker 602, gradually dampening amplitude of motion and, thereby, reducing the sound emitted from the device 600. Full engagement of the interference device 613 to the off state (FIG. 27) moves the interference device 613 to interfere with contact between the external ringer 601 and the internal striker 602 such that little or no sound is emitted from the device 600.

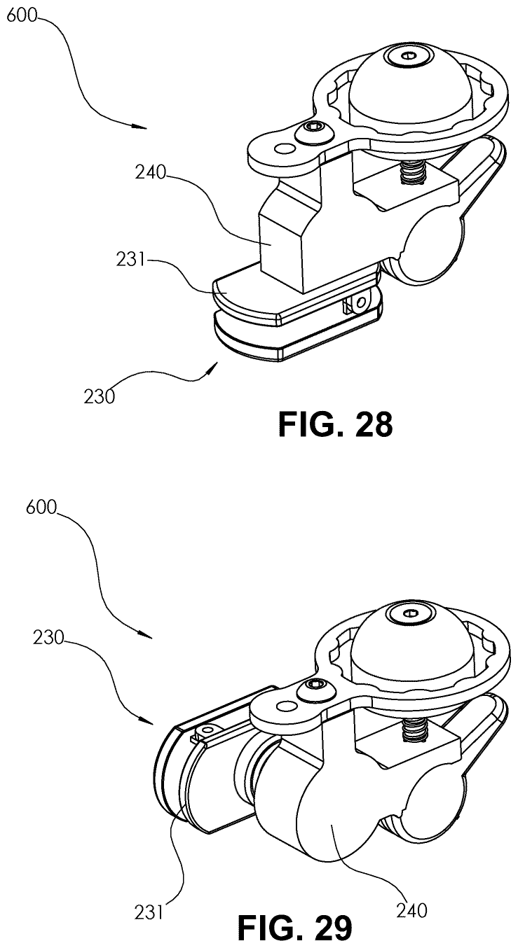

FIG. 28 illustrates a perspective view of an embodiment of the switchable mechanical motion activated sound device 600 (which can be any of the embodiments of device 600 disclosed herein) wherein a clip device 230 can be coupled to a base member 240 of the switchable mechanical motion activated sound device 600. In the embodiment shown, the base member 240 is above the clip device.

FIG. 29 illustrates a perspective view of the switchable mechanical motion activated sound device 600 (which can be any of the embodiments of device 600 disclosed herein) wherein the attachment device 230 can be coupled to a side of the sound device and can be coupled at the base member 240. In the embodiment shown, a clip device can couple the switchable mechanical motion activated sound device 600 to a thin object such as, but not limited to, a strap, a piece of fabric, or the shoelaces on a child's shoe.

FIG. 30 illustrates a perspective view of the switchable mechanical motion activated sound device 600 (which can be any of the embodiments of device 600 disclosed herein) wherein the attachment device at the bottom of the device can be coupled to a strap 220. In the embodiment shown, the strap can be secured with a side release buckle 222, and 221. The sound device can be configured to couple to the strap in any orientation and the strap can use a plurality of other coupling devices.

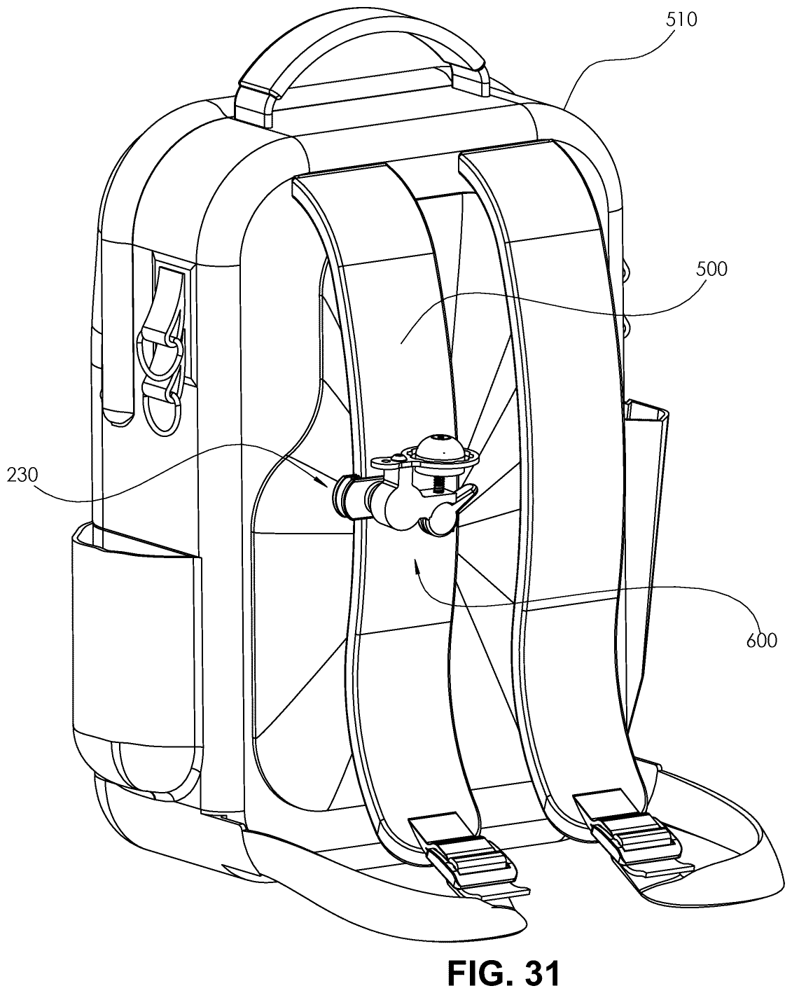

FIG. 31 illustrates a perspective view of the switchable mechanical motion activated sound device 600 (which can be any of the embodiments of device 600 disclosed herein) wherein the sound device can be coupled to a backpack 510. The embodiment shown can use a clip device 230 with the clip device coupled to the side of the base member 240 as shown in FIG. 29.

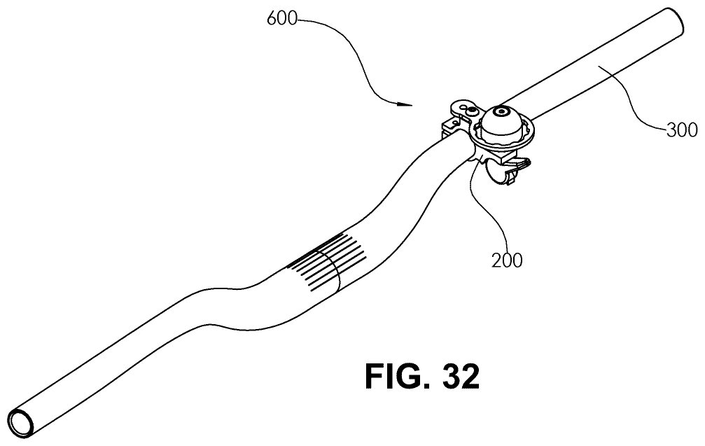

FIG. 32 illustrates a perspective view of the switchable mechanical motion activated sound device 600 (which can be any of the embodiments of device 600 disclosed herein) wherein the sound device can be coupled to a handlebar 300. The embodiment shown can use a bar mount 200.

One purpose of these embodiments is to mitigate the severity of interaction with an audible alert before the cyclist is visible to a pedestrian, wildlife, other cyclist, or other trail user. The device can be easily switched off when audible alerts are not desired. A user carrying this device can reduce the risk of being charged or attacked by wildlife. Embodiments of the device also can be used on pets or children to audibly track their location, but can be easily switched off when the motion-activated sound is not desired.

Other embodiments can include one or more of the following options.
a device which emits sound;
an attachment device configured to couple the device to a person, animal, bicycle, other device, or some combination thereof.
3. The sound emitting device wherein the threshold of movement, above which the device emits sound, is configurable.
4. The sound emitting device wherein a volume of the sound emitted is adjustable.
5. The sound emitting device wherein an interval between emissions of the sound or sequence of sounds is adjustable.
determining, based on the first signal, whether the movement of the device is above a threshold movement level; and
in response to determining the movement of the device is above the threshold movement level, transmitting a second signal to cause the device to emit the sound.
determining a distance between the device and a computing device external to the device; and
based on the distance, causing the computing device to emit the sound.
determine, based on the first signal, whether the movement of the device is above a threshold movement level; and
in response to determining the movement of the device is above the threshold movement level, transmit a second signal to cause the device to emit the sound.

Still other embodiments can include one or more of the following options.
1. A device for selectively emitting sound produced by mechanical contact, the device comprising:
a mount configured to couple the device to an object;
a ringer coupled to the mount;
a striker coupled to the mount;
an actuator coupled to the mount and to one of the ringer and the striker, the actuator has an on position wherein the ringer and striker are free to make mechanical contact and configured to emit sound when the device is in motion, and the actuator has an off position wherein the actuator does one of the following:
positions the striker away from the ringer to prevent or reduce contact and mechanical sound made by contact between the ringer and striker; or
positions the ringer away from the striker to prevent or reduce contact and mechanical sound made by contact between the ringer and striker.
2. The device wherein at least a portion of the ringer is circular in shape, and the ringer is configured to be variably damped to selective reduce sound between the on and off positions.
3. The device wherein the ringer comprises a bar.
4. The device wherein the ringer comprises a bell and, in the off position, one of the ringer and striker is not immobilized or stationary.
5. The device wherein the ringer comprises a fork-like shape.
6. The device wherein the striker comprises a clapper.
7. The device wherein at least a portion of the striker is circular in shape.
8. The device wherein the striker is external relative to the ringer.
9. The device wherein the striker is internal relative to the ringer.
10. The device wherein the striker is adjacently coupled to the ringer, the striker and ringer are co-axial relative to an axis and, in the off position, there is no axial overlap between the striker and ringer.
11. The device wherein the striker comprises a plurality of strikers, or the ringer comprises a plurality of ringers.
12. The device wherein at least one of the strikers can be manually operated to strike the ringer independent of whether the device is in motion.
13. The device wherein at least one of the ringers can be manually operated to strike the striker independent of whether the device is in motion.
14. A device for selectively emitting sound made by mechanical contact, the device comprising:
a mount configured to couple the sound device to an object;
a ringer coupled to the mount;
a striker coupled to the mount;
a blocker coupled to the mount;
an actuator coupled to the mount and to the blocker, the actuator has an on position wherein the blocker is configured to not impede mechanical contact between the ringer and striker to make sound when the device is in motion, and the actuator has an off position wherein the blocker is configured to impede mechanical contact between the ringer and striker to prevent sound when the device is in motion.
15. The device wherein at least a portion of the ringer is circular in shape, and the ringer is configured to be variably damped to selective reduce sound between the on and off positions.
16. The device wherein the ringer comprises a bar.
17. The device wherein the ringer comprises a bell and, in the off position, one of the ringer and striker is not immobilized or stationary.
18. The device wherein the ringer comprises a fork-like shape.
19. The device wherein the striker comprises a clapper.
20. The device wherein at least a portion of the striker is circular in shape.
21. The device wherein the striker is external relative to the ringer.
22. The device wherein the striker is internal relative to the ringer.
23. The device wherein the striker is adjacently coupled to the ringer, the striker and ringer are co-axial relative to an axis and, in the off position, there is no axial overlap between the striker and ringer.
24. The device wherein the striker comprises a plurality of strikers, or the ringer comprises a plurality of ringers.
25. The device wherein at least one of the strikers can be manually operated to strike the ringer independent of whether the device is in motion.
26. The device wherein at least one of the ringers can be manually operated to strike the striker independent of whether the device is in motion.

The foregoing description, for purposes of explanation, used specific nomenclature to provide a thorough understanding of the embodiments. However, it will be apparent to one skilled in the art that the specific details are not required to practice the embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A motion-activated mechanical sound-emitting device comprising: a mount configured to couple the device to an object; at least one ringer having a striking surface; at least one striker disposed outside the at least one ringer; and an actuator operable by a user to select between an on state and an off state; wherein, for each striker and for each ringer that the striker is configured to contact in the on state, the striker is coupled exclusively to support structure located outside that ringer, and no portion of any pivot, anchor, guide, bushing, retention feature, or fastener for that striker is disposed within or passes through that ringer; wherein, in the on state, motion of the device permits at least one striker to contact at least one ringer that the striker is configured to contact to emit sound; and wherein, in the off state, the actuator prevents contact between each striker and every ringer that the striker is configured to contact by performing at least one of: (i) moving at least one of the striker and the ringer to a spaced-apart position in which contact cannot occur during motion of the device; or (ii) interposing a blocker in a position that prevents the striker from contacting any ringer that the striker is configured to contact.

2. The device of claim 1, wherein the actuator is positionable at one or more intermediate positions between the on and off states to provide partial or graduated reduction in sound by restricting motion that would otherwise permit unimpeded contact between any striker and any ringer that the striker is configured to contact.

3. The device of claim 1, wherein no through-fastener or anchor associated with any striker passes through any ringer.

4. The device of claim 1, wherein each striker is carried by an exterior bracket, hinge, or slider mounted to an exterior of the device.

5. The device of claim 1, wherein, in both the on state and the off state, no portion of any striker extends into or through any ringer.

6. The device of claim 1, wherein, when engaged, the blocker is positioned between the striker and the striking surface of the ringer to impede contact.

7. The device of claim 1, wherein the device is operable when mounted in any orientation.

8. The device of claim 1, wherein the actuator is spring-free.

9. The device of claim 1, wherein at least one striker and at least one ringer are coaxial, and in the off state there is no axial overlap between them.

10. The device of claim 1, wherein the off state is achieved by moving a striker away from its associated ringer.

11. The device of claim 1, wherein the off state is achieved by moving a ringer away from an associated striker.

12. The device of claim 1, wherein the off state is achieved by coordinated movement of a striker and an associated ringer away from one another.

13. The device of claim 1, wherein the ringer is formed of a first material that acoustically resonates upon mechanical impact, and the striker is formed of a second material having a hardness greater than that of the first material such that impact by the striker excites resonance of the ringer.

14. A method of operating a motion-activated mechanical sound-emitting device, the device comprising a mount, at least one ringer having a striking surface, at least one striker disposed outside the at least one ringer, and an actuator operable by a user to select between an on state and an off state, wherein, for each striker and for each ringer that the striker is configured to contact in the on state, the striker is coupled exclusively to support structure located outside that ringer and no portion of any pivot, anchor, guide, bushing, retention feature, or fastener for that striker is disposed within or passes through that ringer, the method comprising: manipulating the actuator to select the on state; exposing the device to motion such that at least one striker contacts at least one ringer that the striker is configured to contact to emit sound; manipulating the actuator to select the off state; and in the off state, preventing contact between each striker and every ringer that the striker is configured to contact by performing at least one of: (i) moving at least one of the striker and the ringer to a spaced-apart position in which contact cannot occur during motion of the device; or (ii) interposing a blocker in a position that prevents the striker from contacting any ringer that the striker is configured to contact.

15. The method of claim 14, further comprising positioning the actuator at one or more intermediate positions between the on and off states to provide partial or graduated reduction in sound by restricting motion that would otherwise permit unimpeded contact between any striker and any ringer that the striker is configured to contact.

16. The method of claim 14, wherein preventing contact in the off state comprises moving a striker away from its associated ringer.

17. A system for emitting a mechanical sound upon motion, comprising: a host article; and a motion-activated mechanical sound-emitting device mounted to the host article, the device comprising: a mount configured to couple the device to the host article; at least one ringer having a striking surface; at least one striker disposed outside the at least one ringer; and an actuator operable by a user to select between an on state and an off state; wherein, for each striker and for each ringer that the striker is configured to contact in the on state, the striker is coupled exclusively to support structure located outside that ringer, and no portion of any pivot, anchor, guide, bushing, retention feature, or fastener for that striker is disposed within or passes through that ringer; wherein, in the on state, motion of the host article permits at least one striker to contact at least one ringer that the striker is configured to contact to emit sound; and wherein, in the off state, the actuator prevents contact between each striker and every ringer that the striker is configured to contact by performing at least one of: (i) moving at least one of the striker and the ringer to a spaced-apart position; or (ii) interposing a blocker to prevent contact.

18. The system of claim 17, wherein the host article comprises a bicycle and the device is mounted to a handlebar, seat post, or frame component.

19. The system of claim 17, wherein the device is operable when mounted to the host article in any orientation.

20. The system of claim 17, wherein no aperture of any ringer receives any portion of any striker or any striker-supporting component.
